(19) United States
(12) Patent Application Publication
(10) Pub. No.: US 2009/0198610 A1
(43) Pub. Date: Aug. 6, 2009

(54) Credit Risk Prediction And Bank Card Customer Management By Integrating Disparate Data Sources

(76) Inventors: Mingyang Wu, San Diego, CA (US); Joseph Beals, Corte Madera, CA (US); Edmond Dean Chow, Encinitas, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/024,061

(22) Filed: Jan. 31, 2008

(51) Int. Cl. G06Q 40/00

(52) U.S. Cl. 705/38

(57) ABSTRACT

A future behavior prediction system includes a scoring engine to generate a final prediction score for a credit account holder from a combination of two or more variable summaries. Each variable summary is a summary of variable data from one of a number of data sources. The number of data sources include at least a master billing data source and an authorization transaction data source.

### BACKGROUND

This disclosure relates generally to credit risk prediction systems, and more particularly to a system and method for integrating disparate data sources for improved credit risk prediction.

Prediction of future customer behavior is a fundamental concern for many financial applications. For example, the effectiveness of a credit card customer management system largely depends on the accuracy of its credit risk models, which predict the likelihood of a customer becoming seriously delinquent or bankrupt in the near future. In addition to credit risk, a bank card customer management system typically employs a number of other models, such as attrition, revenue, and profit models. Attrition models predict how likely a customer is to attrite from an existing bank card relationship, while revenue and profit models predict the revenue and profit a customer will produce in a future period.

More predictive models lead to better decisions and better managed card portfolios. Consequently, considerable effort has been devoted to improving the performance of these models. Among the methods that improve model prediction, employing additional data sources consistently provides substantial benefits in practice. As an example, many account management systems use only master-billing information to evaluate credit risk. Performance of risk models can improve considerably when master-billing data is supplemented with another information source, such as card transactions.

To provide other data sources to existing predictive models, or more precisely, to integrate disparate data sources to yield improved analytics, is not trivial. FIG. 1 illustrates a straightforward and commonly-used approach, in which all the raw data from a number of data sources 102 is gathered to a centralized location 104, which includes an aggregator to derive variables and scores from the combined data feeds. This approach, however, requires complex system integration solutions and therefore is likely to incur substantial costs. The data sources usually originate from entirely separate systems, some of which provide a large amount of data; transmitting all data to the centralized location 104 is expensive and may require substantial modification of existing systems. Furthermore, a sophisticated scoring system 106 having a full-fledged credit risk model that can process the data collected from the various sources must be installed at the centralized location 104. Finally, the resulting scores are transmitted to the ultimate decisioning system 108.

### SUMMARY

To overcome some of the problems described above, a system and method for predicting a credit risk of a credit account holder is presented. Instead of delivering all data to a centralized location, each source is first summarized into a handful of variables or a score (a single variable). Then the “distilled” variables from different sources are combined into a final score. This approach offers a number of benefits over a centralized scoring system. The data transmission costs are considerably reduced: Instead of passing on a large amount of data, only a few variables are transmitted on each individual. In practice, many source systems from which data feeds originate are also data processing systems; thus the summarization of the data from a particular source system may be implemented using a mechanism native to the source system. This allows leveraging of existing source systems, thereby further reducing the integration costs.

In particular, a method of credit risk prediction by integrating disparate data sources, such as credit card master-billing and transaction information, is presented. The disparate data sources represent distinct aspects of an overall risk profile. A particular combination and integration of information from these data sources yields better predictions than any single source individually, or even techniques which first aggregate the raw data feeds from various sources to a centralized location and then compute risk scores from the ensemble.

According to one method, each data source is summarized into a handful of variables or a single score. These variables are then combined into a final score. This method substantially reduces the cost of integration by better leveraging existing systems, and reducing the complexity of integration and the need for additional system communications. Moreover, this method provides a natural componentization of the analytics associated with each of the data sources and offers additional operational flexibility. As an application of the proposed idea, we show how we integrate master-billing information with transaction information to yield a credit risk score superior to existing master-billing-based scores.

In one aspect, a future behavior prediction system includes a scoring engine to generate a final prediction score for a credit account holder from a combination of two or more variable summaries. Each variable summary is a summary of variable data from one of a number of data sources, which include at least a master billing data source and an authorization transaction data source.

In another aspect, a behavior prediction scoring system includes a server connected with a network and adapted to receive information from a plurality of client computers that provide data sources. The data sources include at least a master billing data source and an authorization transaction data source. The server hosts a scoring engine to generate a final score for a credit account holder from a combination of the two or more variable summaries, each variable summary being a summary of variable data from the data sources.

In yet another aspect, a method for predicting a future behavior of an account holder includes the steps of combining two or more variable summaries in a centralized scoring engine, each variable summary being a summary of variable data from one of a number of data sources, including at least a master billing data source and an authorization transaction data source. The method further includes the centralized scoring engine generating a final score representative of the future behavior of the account holder based on the combined two or more variable summaries.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a prior art approach to credit risk prediction.

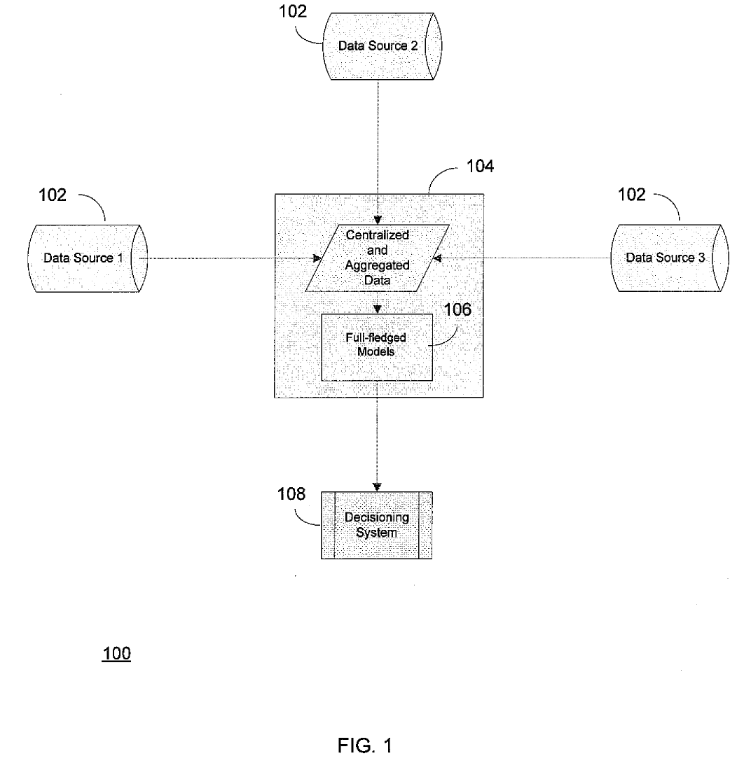

FIG. 2 is a schematic illustration of a credit risk prediction system in accordance with preferred implementations.

FIG. 3 illustrates an implementation of a credit risk prediction system.

FIG. 4 illustrates a method for predicting credit risk.

FIGS. 5A and 5B show the most and the least risky score ends of trade-off curves for a conventional Behavior score and a Transaction-enhanced Behavior score, respectively.

Like reference symbols in the various drawings indicate like elements.

### DETAILED DESCRIPTION

This document describes a system and method of credit risk prediction by integrating disparate data sources, in which each of the disparate data sources is summarized or distilled into one or more variables or a score (a single variable). The “distilled” variables are then combined into a final score.

In accordance with preferred implementations, a method for determining a credit risk of an account holder includes the step of summarizing each of two or more data sources into one or more variable summaries. Each of the two or more data sources includes information related to the account holder. The data sources include at least a master billing data source and a transaction data source. The method further includes the step combining the one or more variable summaries to generate a final score representing the credit risk of the account holder.

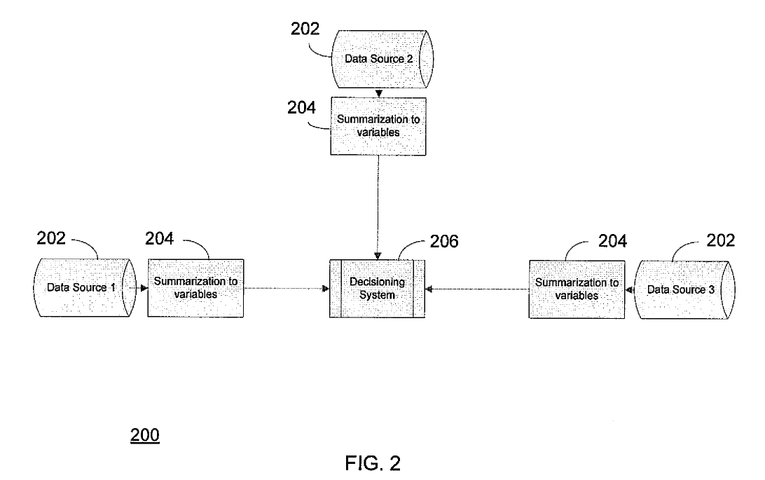

FIG. 2 is a schematic illustration of a prediction system 200 in accordance with preferred implementations. The prediction system 200 can be used, among many applications, for predicting credit risk of an individual, or predicting an outcome of a transaction or set of transactions. A number of disparate data sources 202, represented in FIG. 2 as “Data Source 1”, “Data Source 2”, and “Data Source 3”, each provide data to a summarization module 204, which summarizes the data into a set of summary variables. While each data source 202 may be different from each other data source, they are preferably associated with a common entity, such as a credit account or credit account holder. The individual sets of summary variables are then sent to a decisioning system 206, which includes a scoring engine to generate a final credit score for a credit account holder.

The individual summarization of each data source 202 provides a natural modularization of the analytics associated with each data source 202. For instance, one set of summary variables may be viewed as a master-billing component of a credit account, and another set as the transaction component of the credit account. This componentization provides additional operational flexibility. For example, an analyst can directly employ a score distilled from one data source 202 as a decision key in a strategy, or can create strategies that combine a distilled score with variables from other data sources 202. Also, variables summarized from one or more data sources 202 can be adjoined with other data sources not yet considered in the current integration to serve as inputs to new models. Finally, new data sources 202 can be added to this system with relatively small incremental integration cost.

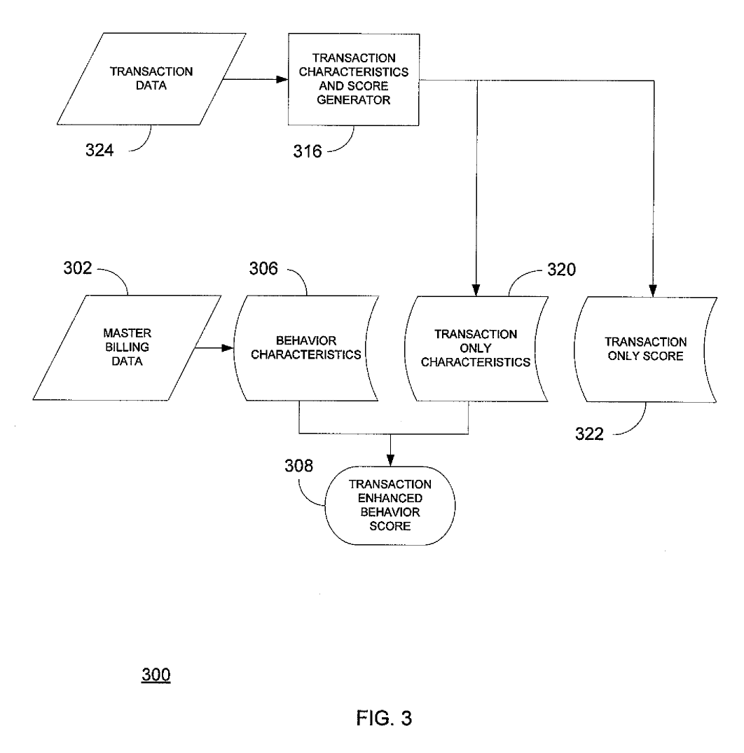

In accordance with preferred implementations, and as illustrated in an exemplary implementation shown in FIG. 3, data sources include at least a master billing data source 302 and a transaction data source 324. The master billing data source 302 includes master-billing information, such as credit line, balance, monthly payment information, interest charged, and delinquency status, to predict credit risk of individual cardholders. One example data source for master-billing information is Fair Isaac's TRIAD platform, a leading bankcard account management system. The master-billing information is aggregated into a number of variables, known as behavior characteristics 306, which are predictive of a card holder's future behavior.

The transaction data source 324 includes transaction-based authorization and payment information, which can be used to improve credit risk prediction. For example, Fair Isaac's TRIAD Transaction Scores (TTS) yield superior performance over master-billing based scores through the use of transaction data. An example data source for transaction information is Fair Isaac's Falcon platform, a leading bank card fraud detection system. Transaction characteristics and score generator 316 aggregates transactions, such as purchases and cash advances, into transaction-only characteristics 320, which are summaries of a card's historical spending behavior specifically attuned to detecting credit risk, and transaction-only credit risk scores 322.

The master-billing data 302 and the authorization transaction data 324 complement each other when properly summarized into useful summary variables. Combining these two data sources in accordance with the methods described above permits the development and implementation of a superior credit risk score while leveraging existing master billing data and transaction data platforms as much as possible.

Often, the master-billing data platform is not only a data source for master-billing information, but also a decisioning system for executing strategies. This is the case for Fair Isaac's TRIAD platform. Thus the transaction-only characteristics 320 and transaction-only score 322 from the transaction platform can be transmitted directly to the master-billing data platform. Also, as described above, master-billing information is already summarized into a number of Behavior characteristics 306. The transaction-only characteristics 320 are then combined with the Behavior characteristics 306 to produce a Transaction-enhanced Behavior Score 308 via a set of scorecards developed from both sets of characteristics.

Furthermore, the systems and methods described herein naturally separate the transaction component from the master-billing component. An analyst can utilize the transaction-only score 322 directly as a decision key in a master-billing data based decision, instead of developing a Transaction-enhanced Behavior Score 308 that combines both sets of characteristics. This direct use of a transaction-only score 322 is appealing to clients who intend to develop their own analytic models, but who have Limited expertise with transaction data analytics. The transaction-only characteristics 320 themselves can also be used as inputs in other models.

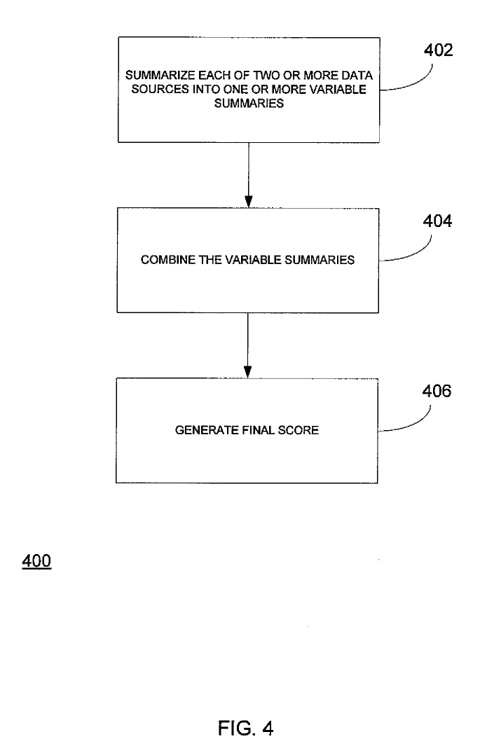

FIG. 4 is a flowchart of a method 400 for predicting future behavior of an account holder. The future behavior can be related to a credit risk, a likelihood of becoming delinquent on a debt, a likelihood of becoming bankrupt, or other behaviors. At 402, each of two or more data sources are summarized into one or more variable summaries. Each of the two or more data sources includes information related to the account holder. The data sources include at least a master billing data source and an authorization transaction data source. At 404, the one or more variable summaries are combined, and at 406 a final score representing the predicted future behavior of the account holder is generated.

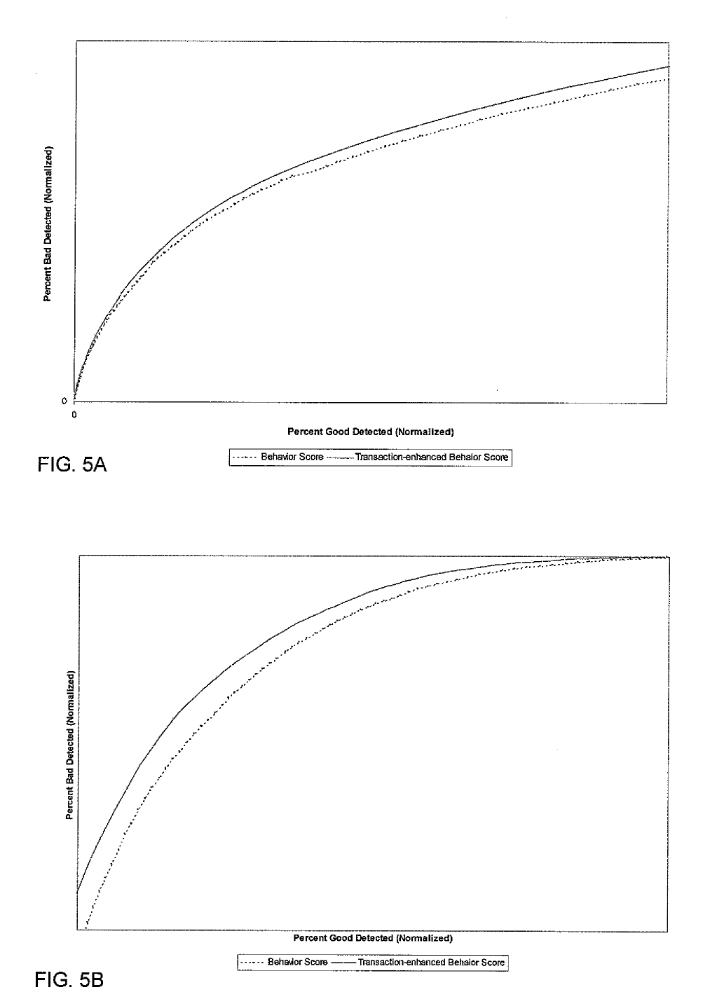

FIGS. 5A and 5B show the most risky and the least risky score ends, respectively, of the trade-off curves for a conventional Behavior score and a Transaction-enhanced Behavior score. As can be seen, the Transaction-enhanced Behavior Score substantially outperforms the Behavior Score.

This approach offers a number of benefits. The data transmission costs are considerably reduced: Instead of passing on a large amount of data, only a few variables are transmitted on each individual. In practice, many source systems from which data feeds originate are also data processing systems; thus the summarization of the data from a particular source system may be implemented using a mechanism native to the source system. This allows leveraging of existing source systems, thereby further reducing the integration costs.

Even if the summarization cannot be implemented in a native mechanism, the complexity of an add-on summarization system is substantially less than that of the central scoring system since, in essence, the add-on summarization deals with only one greatly reduced data feed. Given the relatively small number of variables available at the final combination stage, the final score can be rendered via relatively simple and easy to implement mathematical formulae such as scorecards or regressions. In fact, the final combination formulae are likely to be simple enough to be implemented in the ultimate decisioning system. This will eliminate entirely the need for a centralized location, and again leverages existing decisioning systems.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PIDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A future behavior prediction system comprising:
a scoring engine to generate a final prediction score for a credit account holder from a combination of two or more variable summaries, each variable summary being a summary of variable data from one of a plurality of data sources, the plurality of data sources including at least a master billing data source and an authorization transaction data source.

2. A system in accordance with claim 1, wherein the master billing data source includes master billing information about the credit account holder that represents a number of behavioral characteristic variables.

3. A system in accordance with claim 2, wherein the billing information includes a credit line, a balance, a payment information, an interest rate, and/or a delinquency status related to the credit account holder.

4. A system in accordance with claim 1, wherein the authorization transaction data source includes transaction information that represents historical spending behavior variables.

5. A system in accordance with claim 4, wherein the transaction information includes information about purchases and/or cash advances related to the credit account holder.

6. A method for predicting future behavior of an account holder, the method comprising:
summarizing each of two or more data sources into one or more variable summaries, each of the two or more data sources having information related to the account holder and including at least a master billing data source and an authorization transaction data source; and
combining the one or more variable summaries to generate a final score representing the predicted future behavior of the account holder.

7. A method in accordance with claim 6, wherein the master billing data source includes master billing information about the credit account holder that represents a number of behavioral characteristic variables.

8. A method in accordance with claim 7, wherein the billing information includes a credit line, a balance, a payment information, an interest rate, and/or a delinquency status related to the credit account holder.

9. A method in accordance with claim 6, wherein the authorization transaction data source includes transaction information that represents historical spending behavior variables.

10. A method in accordance with claim 9, wherein the transaction information includes information about purchases and/or cash advances related to the credit account holder.

11. A behavior prediction scoring system comprising:
a server connected with a network and adapted to receive information from a plurality of client computers providing data sources that include at least a master billing data source and an authorization transaction data source, the server hosting a scoring engine to generate a final score for a credit account holder from a combination of the two or more variable summaries, each variable summary being a summary of variable data from the data sources.

12. A system in accordance with claim 1 1, wherein the master billing data source includes master billing information about the credit account holder that represents a number of behavioral characteristic variables.

13. A system in accordance with claim 12, wherein the billing information includes a credit line, a balance, a payment information, an interest rate, and/or a delinquency status related to the credit account holder.

14. A system in accordance with claim 11, wherein the authorization transaction data source includes transaction information that represents historical spending behavior variables.

15. A system in accordance with claim 14, wherein the transaction information includes information about purchases and/or cash advances related to the credit account holder.

16. A method for predicting a future behavior of an account holder, the method comprising:
combining two or more variable summaries in a centralized scoring engine, each variable summary being a summary of variable data from one of a plurality of data sources, the plurality of data sources including at least a master billing data source and an authorization transaction data source; and
the centralized scoring engine generating a final score representative of the future behavior of the account holder based on the combined two or more variable summaries.

17. A method in accordance with claim 16, wherein the master billing data source includes master billing information about the credit account holder that represents a number of behavioral characteristic variables.

18. A system in accordance with claim 17, wherein the billing information includes a credit line, a balance, a payment information, an interest rate, and/or a delinquency status related to the credit account holder.

19. A system in accordance with claim 16, wherein the authorization transaction data source includes transaction information that represents historical spending behavior variables.

20. A system in accordance with claim 19, wherein the transaction information includes information about purchases and/or cash advances related to the credit account holder.
